(19) United States
(12) Patent Application Publication
(10) Pub. No.: US 2022/0312779 A1
(43) Pub. Date: Oct. 6, 2022

(54) SYSTEM AND METHOD FOR CONSTRUCTING A GINGERBREAD HOUSE

(71) Applicant: LAUREN BROOKS, OKLAHOMA CITY, OK (US)

(72) Inventor: LAUREN BROOKS, OKLAHOMA CITY, OK (US)

(21) Appl. No.: 17/690,195

(22) Filed: Mar. 9, 2022

Related U.S. Application Data
(60) Provisional application No. 63/168,373, filed on Mar. 31, 2021.

(51) Int. Cl. A21C 15/02; A21D 13/47; A23G 3/56

(52) U.S. Cl. CPC A21C 15/025; A21D 13/47; A23G 3/563

(57) ABSTRACT

According to one embodiment a kit and associated construction method are provided. In some embodiments the kit includes a transparent template or form in the shape of a traditional gingerbread house. The form has a ledge that extends outwardly from its lower permiter and provides a support surface upon which the wall gingerbread components can rest after they have been installed. When purchased, the template is preferably housed within a house-shaped cardboard box together with the materials required to decorate the structure. The exterior of the box contains an image that provides decorating inspiration for the gingerbread house kit. The contents of an embodiment of the kit include a transparent plastic form, prebaked gingerbread pieces, cookie icing, glittery sugar and assorted candy accessories.

### CROSS REFERENCE TO RELATED APPLICATIONS

This application claims the benefit of U.S. Provisional Patent Application Ser. No. 63/168,373 filed on Mar. 31, 2021, and incorporates said provisional application by reference into this document as if fully set out at this point.

### TECHNICAL FIELD

The instant invention relates generally to kits for construction of play items and, more specifically, to kits and methods of constructions of gingerbread houses.

### BACKGROUND

Making and decorating gingerbread houses has long been a Christmas tradition in this and many other countries. Some sources trace the genesis of gingerbread houses as far back as ancient Rome, although the gingerbread house as we know it today likely originated in Germany in the 1800s. Generally speaking, a gingerbread house is a novelty confectionary item shaped like a building that has four walls that are comprised of baked gingerbread dough or, in some cases, ginger biscuits which are a crisper variety of gingerbread and more amenable to being formed into planar shapes. Gingerbread is spicy cake-like consumable that is flavored with a ginger spice.

The roof of a gingerbread house may be decorated with white frosting to represent snow or candy to represent roof tiles. The walls may be decorated with edible glitter or candy ornaments depending on the aesthetic vision of the individual who is constructing the house. Additional decoration may be added around the base of the house to simulate, for example, accumulated snow or to provide icons related to winter or the Christmas holiday, e.g., snowmen, wrapped presented, etc. Further, although simple houses are typically made, other more-complex structures are certainly possible. Many permutations of the type of structure and decorative additions are certainly possible and well within the ability of one of ordinary skill in the art.

Although constructing a gingerbread house is often conceptualized as a fun family activity its successful construction may require a level of skill not available to all. That is, forming a free standing structure that has four vertical walls and a peaked roof from a building material such a gingerbread can be a daunting task. Further, attempting to decorate the walls and roof to to create an attractive structure may not result in the sort of finished product that might have originally been imagined either because the necessary materials were not at hand or the individuals did not have the requisite creative skill. This is made still more complicated in that a many gingerbread house kits include cookie-cutter shapes that the user is told use to form the sides and roof of the house and then assemble these separate pieces into a free standing structure that is sturdy enough to decorate. Assembly of a structure from such a kit such as this can be taxing to the patience of the user.

Thus, what is needed is a method of creating a gingerbread house that does not suffer from the disadvantages of the prior art.

Before proceeding to a description of the present invention, however, it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### SUMMARY OF THE INVENTION

An embodiment of the invention comprises a kit and associated construction method that includes a template or form, preferably made of a transparent or translucent plastic, in the shape of a traditional gingerbread house. The template has a ledge that extends outwardly from its lower permiter and provides a support surface upon which the wall gingerbread components can rest after they have been installed. When purchased, the kit that contains the template is preferably housed within a house-shaped cardboard box together with the materials required to decorate the structure. The exterior of the box contains an image that provides decorating inspiration for the gingerbread house kit. The contents of the kit in some embodiments include a transparent plastic form, prebaked gingerbread components, cookie icing, glittery sugar and assorted candy accessories.

Upon receipt of the kit, the user is guided to construct the gingerbread house using the plastic form as a base and applying the other components of the kit to the plastic form using the exterior of the box as a general model.

The foregoing has outlined in broad terms some of the more important features of the invention disclosed herein so that the detailed description that follows may be more clearly understood, and so that the contribution of the instant inventors to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

These and further aspects of the invention are described in detail in the following examples and accompanying drawings.

FIG. 1 contains a view of an example of the house-shaped clear plastic form.

FIG. 2 shows an embodiment of the components that might typically be included in the instant gingerbread house kit.

FIG. 3 contains another view of the components of FIG. 2 that shows the gingerbread wall and roof panels extracted from their packaging.

FIG. 4 contains an isometric view of the exterior of a typical box that might contain the components of the instant kit invention.

FIG. 5 contains a side view of the exterior of another box that might contain the components of FIG. 2.

FIG. 6 contains a front view of an assembled gingerbread house using the kit components of FIG. 2.

FIG. 7 contains an example of how an embodiment might be used in practice.

The invention will be described in connection with its preferred embodiments. However, to the extent that the following detailed description is specific to a particular embodiment or a particular use of the invention, this is intended to be illustrative only and is not construed as limiting the invention's scope. On the contrary, it is intended to cover all alternatives, modifications, and equivalents included within the invention's spirit and scope, as defined by the appended claims.

### DETAILED DESCRIPTION

While this invention is susceptible of embodiment in many different forms, there is shown in the drawings, and will be described hereinafter in detail, some specific embodiments of the instant invention. It should be understood, however, that the present disclosure is to be considered an exemplification of the principles of the invention and is not intended to limit the invention to the specific embodiments or algorithms so described.

According to a first embodiment of the invention there is provided a kit that may easily be assembled into a house-shaped gingerbread confectionary item 170. It should be noted, though, that although the walls and roof components are often made of gingerbread dough, in some instances they could alternatively be made from a variety of different kinds of doughs, for example, a white or other sugar dough, a chocolate dough, a cookie dough, a brownie dough, etc. That being said, for purposes of the instant disclosure it should be understood that when the term “gingerbread house” is used that term is being used in a general sense to describe a house-shaped item constructed of edible baked-dough components and decorated with confectionary items, whether or not the walls and roof are actually made of gingerbread. Similarly, when the terms “sweet dough” or “baked sweet dough” are used those terms should be understood as referring generally to any dough generally of the form described previously.

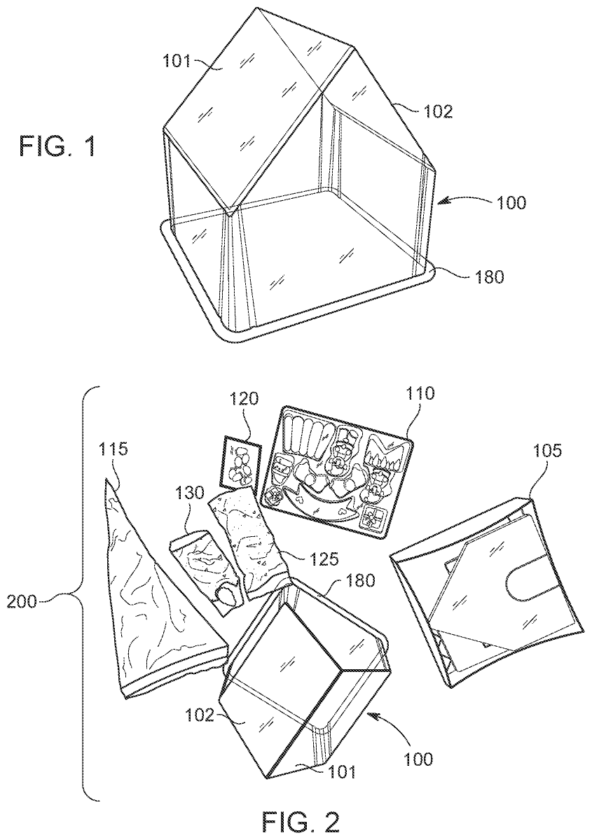

FIG. 1 contains an isolated view of the inventive gingerbread house form 100. As can be seen, it is preferably made of a clear plastic material with a ledge 180 provided around the entire perimeter of its base. As can be readily understood, this base, among other things, provides a resting place for the lower edge of each of the gingerbread pieces that form the wall components 306-308 of the instant embodiment. Each of the wall components 306-308 is sized and shaped to match the corresponding feature on the form 100. Similarly, the roof slabs 309 are sized and shaped to fit the roof planes 101 and 102. The ledge 180 provides support for the gingerbread walls 307-308 which makes it easy to relocate the entire structure after the walls and roof have been applied to the form and the resulting structure decorated. More generally speaking, the form 100 provides a stable substrate to which the gingerbread components 105 can be attached using the frosting/adhesive provided, thereby simplifying the task of building a gingerbread house.

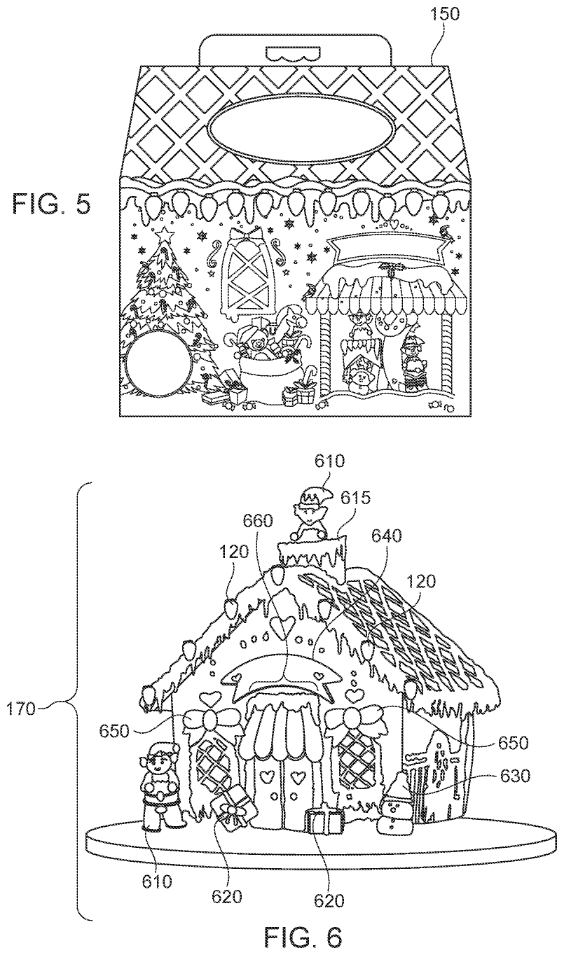

Additionally, included as part of a preferred kit 200 (FIG. 2) are a collection of components that will enable the user to construct an entire gingerbread house 170, FIG. 6. FIG. 4 and FIG. 5 contain examples of the sort of container, preferably a decorated house-shaped cardboard box 150 (FIG. 4, isometric view, FIG. 5, plan view) with a handle 160, that the instant kit 200 might be contained within. That being said, the box exterior might be decorated or not depending on the goals of the manufacturer.

Further, in some embodiments only the form 100, the wall components 306-308, and roof slabs 309 might be included in a kit. This arrangement might be particularly desirable if the goal was to allow the end user to provide the decorating materials. In some cases this more minimal kit could be sold in a decorated box 150 of the sort discussed previously, with the decorations on the box being intended to be a suggestion of how the user might decorate the house after it is assembled.

Continuing with the embodiment of FIG. 2, in this variation embodiment the contents of the kit include an icing piping bag 115 that contains frosting. The icing in the bag 115 is preferably used to decorate the exterior of the gingerbread house and can also function as an adhesive as needed. It is also used to provide a sticky surface to which may be attached different colors of glittery sugar 125/130, i.e., colored sugar crystals which may include edible glitter. In some embodiments the glittery sugar composition might comprise sugar, foot coloring(s), carnauba wax, hydroxypropyl methylcellulose, propylene glycol, mica, titanium, and dioxide. Obviously, by changing the mixture of food colorings different colors of glittery sugar may be produced. This will enable the decorated gingerbread house to have details that are different in color. The icing piping bag 115 makes it possible to create detailed color patches by applying the frosting that is in the bag 115 in a desired pattern and then dropping glittery sugar onto the icing, some of which will adhere to the desired pattern of frosting. Finally, the icing in some embodiments can be used as an adhesive to secure the gingerbread pieces 105 to the form 100. Obviously, multiple colors of icing might be included in a kit 200.

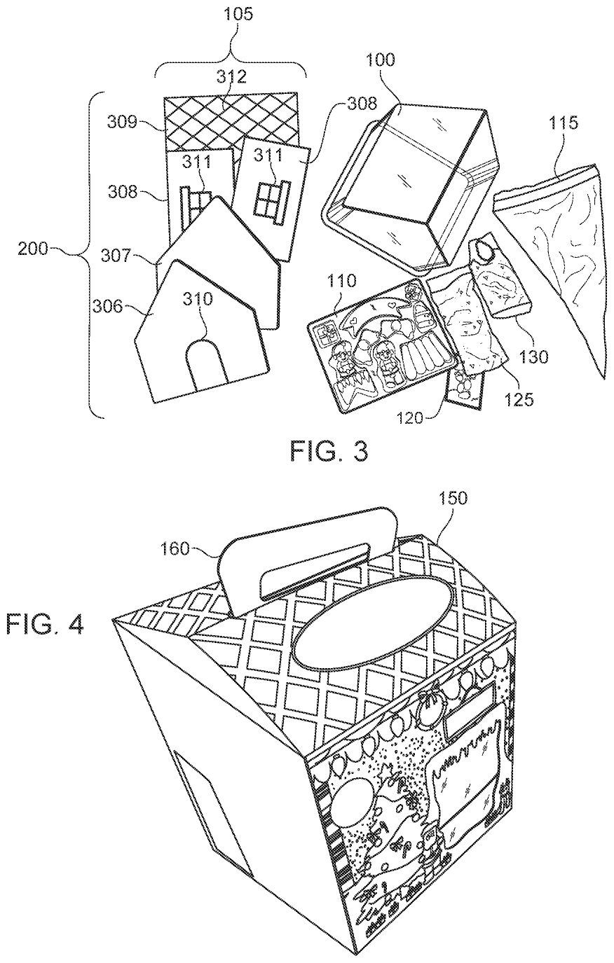

Also preferably included will be sufficient gingerbread pieces 105 to that are sized and shaped to cover the exterior of the form 100. As can be more readily seen in FIG. 3, this kit 200 includes six gingerbread components, one each for the front/back 306/307, two sides 308, and two roof components 309, only one of which is fully visible in FIG. 3. Note that in this variation one of the end pieces 306 contains the outline of a door 310 impressed into the gingerbread, the two side pieces 308 both contain impressed outlines of a window 311, and the roof pieces 309 contain crosshatching 312 that represents the sort of tiling that might be found on a cottage roof. The indentations in the solid gingerbread pieces are intended to be used as guides for the user to assist in placement of the frosting and subsequent application of glittery sugar 125/130.

Additionally, provided in this particular kit are candy elements 120 that are designed to represent Christmas tree lights. They are intended to be applied to the exterior of the gingerbread house as is generally indicated in FIGS. 5 and 6.

Finally, a typical kit 200 might contain additional decorative candy components 110 that might be added to the exterior of assembled gingerbread house in order to improve its aesthetics. In the embodiment of FIG. 6, the elves 610, chimney 615, wrapped packages 620, snow man 630, sign 640, bows 650, and colored candy awning panels 660, are all examples of the sort of Christmas-themed components 110 that might be included.

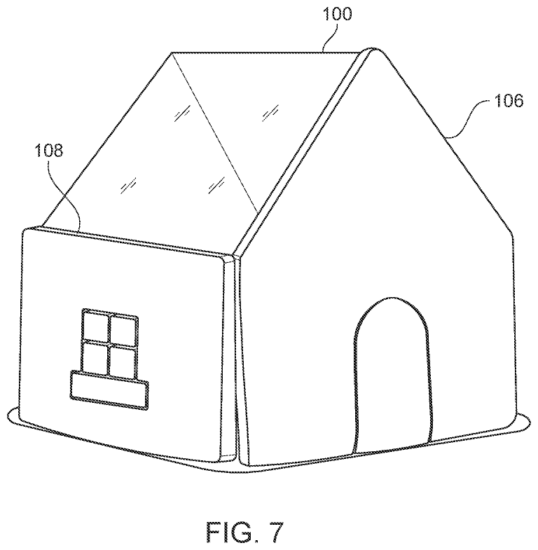

Turning next to FIG. 7, this figure contains an example of how an embodiment might actually be used in practice. In this example, there is a partially constructed gingerbread house made from the kit 200. As can be seen, the pre-shaped gingerbread panels 306 and 308 have been affied to the form 100 in locations that correspond to their respective shapes. By continuing this process with the other gingerbread pieces 105, even a novice can easily construct a gingerbread house that is pleasing visually and results in a sturdy structure that can be decorated later and moved without fear that it will collapse.

Note that although the terms “gingerbread” and “gingerbread pieces” have been used throughout the instant disclosure those terms were only used as examples of various embodiments and those of ordinary skill in the art will recognize how any baked sweet dough could readily be adapted to be used instead of gingerbread.

It should be noted and understood that the invention is described herein with a certain degree of particularity. However, the invention is not limited to the embodiment(s) set forth herein for purposes of exemplification but is limited only by the scope of the attached claims.

It is to be understood that the terms “including”, “comprising”, “consisting” and grammatical variants thereof do not preclude the addition of one or more components, features, steps, or integers or groups thereof and that the terms are to be construed as specifying components, features, steps, or integers.

The singular shall include the plural and vice versa unless the context in which the term appears indicates otherwise.

If the specification or claims refer to “an additional” element, that does not preclude there being more than one of the additional elements.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

For purposes of the instant disclosure, the term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)— (a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Still further, additional aspects of the instant invention may be found in one or more appendices attached hereto and/or filed herewith, the disclosures of which are incorporated herein by reference as if fully set out at this point.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A kit for assembling a gingerbread house, comprising:
(a) a plastic form shaped like the gingerbread house, said plastic form having an exterior comprising a front wall, a back wall, a left side wall, a right side wall, a left roof plane, a right roof plane and an outwardly extending ledge surrounding an entire lower perimeter of said form;
(b) an icing piping bag containing an amount of icing therein;
(c) one or more containers of glittery sugar, each of said one or more containers being a different color;
(d) a plurality of decorative candy components themed to Christmas and for application to the exterior of the gingerbread house; and
(e) a plurality of baked sweet dough pieces sized to fit and cover said exterior of said plastic form, said plurality of baked sweet dough pieces comprising
a front piece, a back piece, a left piece, a right piece, a left roof piece and a right roof piece,
each of said plurality of said baked sweet dough pieces being shaped and sized to cover
said front wall, said back wall, said left side wall, said right side wall, said left roof plane and said right roof plane, respectively, of said exterior of said plastic form.

2. The kit according to claim 1, wherein said plastic form is transparent or translucent.

3. The kit according to claim 1, wherein the plastic form contains no apertures in said front wall, said back wall, said left side wall, said right side wall, said left roof plane or said right roof plane.

4. The kit according to claim 1, wherein one of more of said baked sweet dough pieces contain a design impressed therein.

5. The kit according to claim 4, wherein said front piece contains a door design impressed therein.

6. The kit according to claim 4, wherein the left piece, the right piece or both contain a window design impressed therein.

7. The kit according to claim 4, wherein the left roof piece and the right roof piece contain crosshatching impressed therein.

8. The kit according to claim 1, further comprising:
(f) a box for containing (a) through (e), said box being shaped like the plastic form and containing a printed design on an exterior, said printed design providing a guide for applying said icing, said glittery sugar, and said and said plurality of candy components to said gingerbread pieces.

9. The kit according to claim 8, wherein said box contains a handle.

10. The kit according to claim 1, wherein said plurality of baked sweet dough pieces are all baked gingerbread pieces.

11. The kit according to claim 1, wherein said plurality of baked sweet dough pieces are all either baked cookie dough pieces, baked brownie pieces, or baked sugar dough pieces.

12. A kit for assembling a gingerbread house, comprising:
(a) a plastic form shaped like the gingerbread house, said plastic form having an exterior comprising a front wall, a back wall, a left side wall, a right side wall, a left roof plane, a right roof plane and an outwardly extending ledge surrounding an entire lower perimeter of said form; and
(b) a plurality of baked sweet dough pieces sized to fit and cover said exterior of said plastic form, said plurality of baked sweet dough pieces comprising
a front piece, a back piece, a left piece, a right piece, a left roof piece and a right roof piece,
each of said plurality of said baked sweet dough pieces being shaped and sized to cover
said front wall, said back wall, said left side wall, said right side wall, said left roof plane and said right roof plane, respectively, of said exterior of said plastic form.

13. The kit according to claim 12, wherein said plastic form is transparent or translucent.

14. The kit according to claim 12, wherein the plastic form contains no apertures in said front wall, said back wall, said left side wall, said right side wall, said left roof plane or said right roof plane.

15. The kit according to claim 12, wherein one of more of said baked sweet dough pieces contain a design impressed therein.

16. The kit according to claim 15, wherein said front piece contains a door design impressed therein.

17. The kit according to claim 15, wherein the left piece, the right piece or both contain a window design impressed therein.

18. The kit according to claim 15, wherein the left roof piece and the right roof piece contain crosshatching impressed therein.

19. The kit according to claim 12, further comprising:
a box for containing (a) through (e), said box being shaped like the plastic form and containing a printed design on an exterior, said printed design providing a guide for applying said icing, said glittery sugar, and said and said plurality of candy components to said gingerbread pieces.

20. The kit according to claim 1, wherein said plurality of baked sweet dough pieces are all either baked gingerbread pieces, baked cookie dough pieces, baked brownie pieces, or baked sugar dough pieces.
